(19) United States
(12) Patent Application Publication
(10) Pub. No.: US 2024/0244384 A1
(43) Pub. Date: Jul. 18, 2024

(54) DUAL ACTUATOR BONE CONDUCTION HEARING PROSTHESIS

(71) Applicant: Cochlear Limited, Macquarie University, NSW (AU)

(72) Inventors: Armin AZHIRNIAN, Mölnlycke (SE); Tommy BERGS, Mölnlycke (SE)

(21) Appl. No.: 18/560,213

(22) PCT Filed: May 18, 2022
(86) PCT No.: PCT/IB2022/054646

§ 371 Date: Nov. 10, 2023

Related U.S. Application Data
(60) Provisional application No. 63/214,441, filed on Jun. 24, 2021.

(51) Int. Cl. H04R 25/00; H04R 9/18; H04R 17/10

(52) U.S. Cl. CPC H04R 25/606; H04R 9/18; H04R 17/10; H04R 2460/13

(57) ABSTRACT

An apparatus includes an electromagnetic transducer configured to generate first vibrations having a first range of vibrational frequencies and to transmit the first vibrations along a transmission path from the electromagnetic transducer to a bone fixture affixed to a recipient's body. The apparatus further includes at least one piezoelectric transducer positioned along the transmission path.

### BACKGROUND

### Field

The present application relates generally to systems and methods utilizing a bone conduction auditory system to improve performance across a wide range of auditory frequencies.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises an electromagnetic transducer configured to generate first vibrations having a first range of vibrational frequencies and to transmit the first vibrations along a transmission path from the electromagnetic transducer to a bone fixture affixed to a recipient's body. The apparatus further comprises at least one piezoelectric transducer positioned along the transmission path.

In another aspect disclosed herein, a method comprises generating first vibrations using a first transducer having a first resonance frequency in a range of 300 Hz to 1000 Hz. The method further comprises transmitting the first vibrations along a transmission path to a bone fixture affixed to a recipient's body. The method further comprises generating second vibrations using a second transducer positioned along the transmission path, the second transducer having a second resonance frequency in a range of 2 kHz to 6 kHz. The method further comprises transmitting the second vibrations to the bone fixture.

In another aspect disclosed herein, an apparatus comprises a coupler configured to be reversibly attached to and detached from an abutment in mechanical communication with a fixture affixed to a recipient's body, the abutment extending from the recipient's body. The apparatus further comprises an electromagnetic transducer in mechanical communication with the coupler and configured to generate first vibrations and to transmit the first vibrations from the electromagnetic transducer via the coupler and the abutment to the fixture. The apparatus further comprises at least one piezoelectric transducer positioned between the electromagnetic transducer and the fixture, the at least one piezoelectric transducer configured to generate second vibrations and to transmit the second vibrations to the fixture.

### BRIEF DESCRIPTION OF THE DRAWINGS

Implementations are described herein in conjunction with the accompanying drawings, in which:

FIG. 1A schematically illustrates a portion of an example transcutaneous bone conduction device implanted in a recipient in accordance with certain implementations described herein;

FIG. 1B schematically illustrate a portion of another example transcutaneous bone conduction device implanted in a recipient in accordance with certain implementations described herein;

FIG. 1C depicts a side view of a portion of an example percutaneous bone conduction device in accordance with certain implementations described herein;

FIG. 2A schematically shows a plot of the vibrational frequency bandwidths of an electromagnetic transducer (dashed line), a piezoelectric transducer (dotted line), and the sum of both the bandwidths (solid line) in accordance with certain implementations described herein;

FIG. 2B schematically illustrates an electromagnetic transducer and a piezoelectric transducer in a parallel electrical circuit in accordance with certain implementations described herein;

FIGS. 3A-3G schematically illustrate various examples of an apparatus in accordance with certain implementations as described herein;

FIG. 4 schematically illustrates a cross-sectional view of an example abutment in accordance with certain implementations described herein;

FIG. 5 schematically illustrates an example apparatus comprises a second housing comprising a magnet in accordance with certain implementations described herein; and

FIG. 6 is a flow diagram of an example method in accordance with certain implementations described herein.

### DETAILED DESCRIPTION

Certain implementations described herein provide a dual bone conduction actuator system comprising an electromagnetic transducer and at least one piezoelectric transducer. In certain implementations, the system is configured to overcome various limitations of single actuator systems having a single resonance frequency. By utilizing the electromagnetic transducer to generate vibrations in the low frequency regime (e.g., bass) and the at least one piezoelectric transducer to generate vibrations in the high frequency regime (e.g., treble), certain implementations can significantly increase bandwidth, efficiency, and sound reproduction quality, as compared to single actuator systems. In addition, by utilizing at least one first electrical amplifier optimized for the electromagnetic transducer and at least one second electrical amplifier optimized for the at least one piezoelectric transducer, certain implementations described herein can provide substantially more even electrical impedances, higher efficiencies, and lower sound distortions, as compared to single actuator systems.

The teachings detailed herein are applicable, in at least some implementations, to any type of implantable or non-implantable vibration stimulation system or device (e.g., implantable or non-implantable bone conduction auditory prosthesis device or system). Implementations can include any type of medical device that can utilize the teachings detailed herein and/or variations thereof. Furthermore, while certain implementations are described herein in the context of auditory prosthesis devices, certain other implementations are compatible in the context of other types of devices or systems (e.g., bone conduction headphones; bone conduction speakers; bone conduction microphones; ultrasonic imaging).

Merely for ease of description, apparatus and methods disclosed herein are primarily described with reference to illustrative medical systems, namely active transcutaneous or percutaneous bone conduction auditory prosthesis systems. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from improvement of hearing percepts at vibrational frequency ranges generated by electromagnetic transducers and piezoelectric transducers. Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

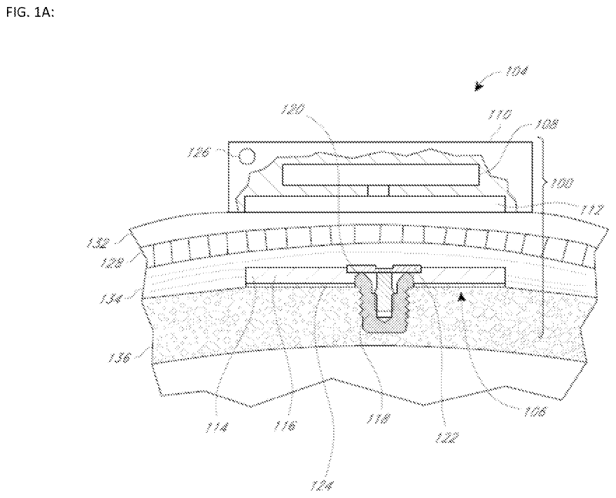

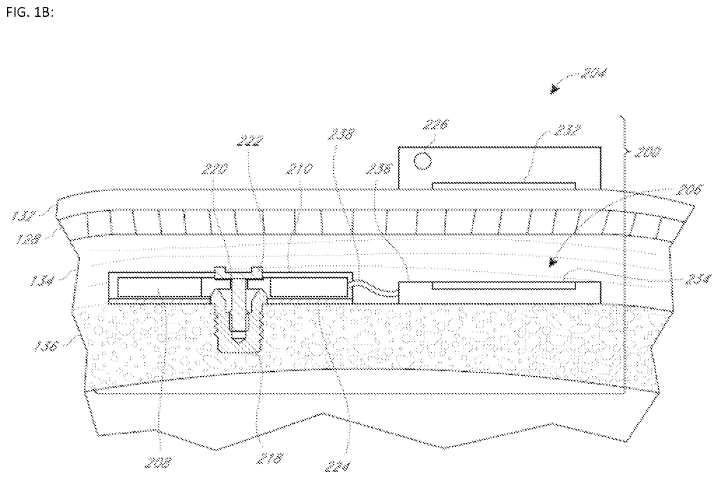

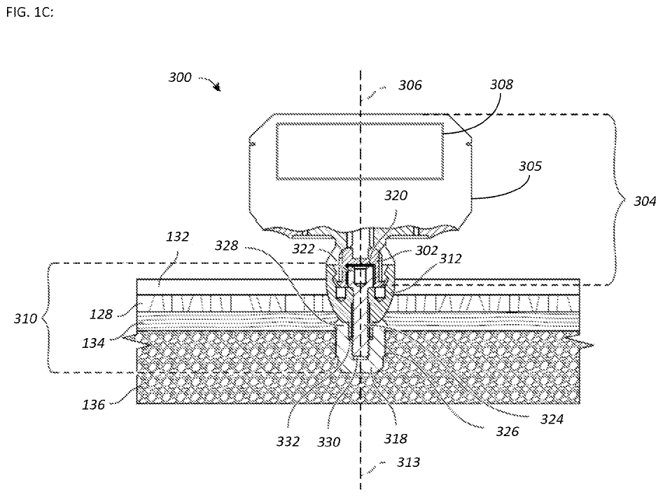

FIG. 1A schematically illustrates a portion of an example transcutaneous bone conduction device 100 implanted in a recipient in accordance with certain implementations described herein. FIG. 1B schematically illustrate a portion of another example transcutaneous bone conduction device 200 implanted in a recipient in accordance with certain implementations described herein. FIG. 1C schematically illustrates a side view of a portion of an example percutaneous bone conduction device 300 in accordance with certain implementations described herein.

The example transcutaneous bone conduction device 100 of FIG. 1A includes an external device 104 and an implantable component 106. The transcutaneous bone conduction device 100 of FIG. 1A is a passive transcutaneous bone conduction device in that at least one vibrating actuator 108 is located in the external device 104 and delivers vibrational stimuli through the skin 132 to the skull 136. The at least one vibrating actuator 108 is located in a housing 110 of the external component 104 and is coupled to a plate 112. The plate 112 can be in the form of a permanent magnet and/or in another form that generates and/or is reactive to a magnetic field, or otherwise permits the establishment of magnetic attraction between the external device 104 and the implantable component 106 sufficient to hold the external device 104 against the skin 132 of the recipient.

In certain implementations, the at least one vibrating actuator 108 is a device that converts electrical signals into vibration. In operation, a sound input element 126 can convert sound into electrical signals. Specifically, the transcutaneous bone conduction device 100 can provide these electrical signals to the at least one vibrating actuator 108, or to a sound processor (not shown) that processes the electrical signals, and then provides those processed signals to the at least one vibrating actuator 108. The at least one vibrating actuator 108 can convert the electrical signals (processed or unprocessed) into vibrations. Because the at least one vibrating actuator 108 is mechanically coupled to the plate 112, the vibrations are transferred from the at least one vibrating actuator 108 to the plate 112. The implanted plate assembly 114 is part of the implantable component 106 and is made of a ferromagnetic material that may be in the form of a permanent magnet, that generates and/or is reactive to a magnetic field, or otherwise permits the establishment of a magnetic attraction between the external device 104 and the implantable component 106 sufficient to hold the external device 104 against the skin 132 of the recipient. Accordingly, vibrations produced by the at least one vibrating actuator 108 of the external device 104 are transferred from the plate 112 across the skin 132 to a plate 116 of the plate assembly 114. This can be accomplished as a result of mechanical conduction of the vibrations through the skin 132, resulting from the external device 104 being in direct contact with the skin 132 and/or from the magnetic field between the two plates 112, 116. These vibrations are transferred without a component penetrating the skin 132, fat 128, or muscular 134 layers on the head.

In certain implementations, the implanted plate assembly 114 is substantially rigidly attached to a bone fixture 118. The implantable plate assembly 114 can include a through hole 120 that is contoured to the outer contours of the bone fixture 118. This through hole 120 thus forms a bone fixture interface section that is contoured to the exposed section of the bone fixture 118. In certain implementations, the sections are sized and dimensioned such that at least a slip fit or an interference fit exists with respect to the sections. A screw 122 can be used to secure the plate assembly 114 to the bone fixture 118. In certain implementations, a silicone layer 124 is located between the plate 116 and the bone 136 of the skull.

As can be seen in FIG. 1A, the head of the screw 122 is larger than the hole through the implantable plate assembly 114, and thus the screw 122 positively retains the implantable plate assembly 114 to the bone fixture 118. The portions of the screw 122 that interface with the bone fixture 118 substantially correspond to an abutment screw, thus permitting the screw 122 to readily fit into an existing bone fixture used in a percutaneous bone conduction device. In certain implementations, the screw 122 is configured so that the same tools and procedures that are used to install and/or remove an abutment screw from the bone fixture 118 can be used to install and/or remove the screw 122 from the bone fixture 118.

As schematically illustrated by FIG. 1B, an example transcutaneous bone conduction device 200 comprises an external device 204 and an implantable component 206. The device 200 is an active transcutaneous bone conduction device in that the at least one vibrating actuator 208 is located in the implantable component 206. For example, at least one vibratory element in the form of at least one vibrating actuator 208 is located in a housing 210 of the implantable component 206. In certain implementations, much like the at least one vibrating actuator 108 described herein with respect to the transcutaneous bone conduction device 100, the at least one vibrating actuator 208 is a device that converts electrical signals into vibration. The at least one vibrating actuator 208 can be in direct contact with the outer surface of the recipient's skull 136 (e.g., the at least one vibrating actuator 208 is in substantial contact with the recipient's bone 136 such that vibration forces from the at least one vibrating actuator 208 are communicated from the at least one vibrating actuator 208 to the recipient's bone 136). In certain implementations, there can be one or more thin non-bone tissue layers (e.g., a silicone layer 224) between the at least one vibrating actuator 208 and the recipient's bone 136 (e.g., bone tissue) while still permitting sufficient support so as to allow efficient communication of the vibration forces generated by the at least one vibrating actuator 208 to the recipient's bone 136.

In certain implementations, the external component 204 includes a sound input element 226 that converts sound into electrical signals. Specifically, the device 200 provides these electrical signals to the at least one vibrating actuator 208, or to a sound processor (not shown) that processes the electrical signals, and then provides those processed signals to the implantable component 206 through the skin of the recipient via a magnetic inductance link. For example, a transmitter coil 232 of the external component 204 can transmit these signals to an implanted receiver coil 234 located in a housing 236 of the implantable component 206. Components (not shown) in the housing 236, such as, for example, a signal generator or an implanted sound processor, then generate electrical signals to be delivered to the at least one vibrating actuator 208 via electrical lead assembly 238. The at least one vibrating actuator 208 converts the electrical signals into vibrations. In certain implementations, the at least one vibrating actuator 208 can be positioned with such proximity to the housing 236 that the electrical leads 238 are not present (e.g., the housing 210 and the housing 238 are the same single housing containing the at least one vibrating actuator 208, the receiver coil 234, and other components, such as, for example, a signal generator or a sound processor).

In certain implementations, the at least one vibrating actuator 208 is mechanically coupled to the housing 210. The housing 210 and the at least one vibrating actuator 208 collectively form a vibrating element. The housing 210 can be substantially rigidly attached to a bone fixture 218. In this regard, the housing 210 can include a through hole 220 that is contoured to the outer contours of the bone fixture 218. The screw 222 can be used to secure the housing 210 to the bone fixture 218. As can be seen in FIG. 1B, the head of the screw 222 is larger than the through hole 220 of the housing 210, and thus the screw 222 positively retains the housing 210 to the bone fixture 218. The portions of the screw 222 that interface with the bone fixture 218 substantially correspond to the abutment screw detailed below, thus permitting the screw 222 to readily fit into an existing bone fixture used in a percutaneous bone conduction device (or an existing passive bone conduction device). In certain implementations, the screw 222 is configured so that the same tools and procedures that are used to install and/or remove an abutment screw from the bone fixture 218 can be used to install and/or remove the screw 222 from the bone fixture 218.

The example transcutaneous bone conduction auditory device 100 of FIG. 1A comprises an external sound input element 126 (e.g., external microphone) and the example transcutaneous bone conduction auditory device 200 of FIG. 1B comprises an external sound input element 226 (e.g., external microphone). Other example auditory devices (e.g., totally implantable transcutaneous bone conduction devices) in accordance with certain implementations described herein can replace the external sound input element 126, 226 with a subcutaneously implantable sound input assembly (e.g., implanted microphone).

In certain implementations, the example percutaneous bone conduction device 300 comprises an operationally removable component 304 and a bone conduction implant 310, as schematically illustrated by FIG. 1C. The operationally removable component 304 comprises a housing 305 and is operationally releasably coupled to the bone conduction implant 310. By operationally releasably coupled, it is meant that it is releasable in such a manner that the recipient can relatively easily attach and remove the operationally removable component 304 during normal use of the percutaneous bone conduction device 300, repeatedly if desired. Such releasable coupling is accomplished via a coupling apparatus 302 of the operationally removable component 304 and a corresponding mating apparatus (e.g., abutment 312) of the bone conduction implant 310, as will be detailed below. This operationally releasable coupling is contrasted with how the bone conduction implant 310 is attached to the skull, as will also be detailed below.

The operationally removable component 304 of certain implementations includes a sound input element (e.g., a microphone; a cable or wireless connection configured to receive signals indicative of sound from an audiovisual device), a sound processor (e.g., sound processing circuitry, control electronics, actuator drive components, power module) configured to generate control signals in response to electrical signals from the sound input element, and at least one vibrating actuator 308 configured to generate acoustic vibrations in response to the control signals. The at least one vibrating actuator 308 can comprise a vibrating electromagnetic actuator, a vibrating piezoelectric actuator, and/or another type of vibrating actuator, and the operationally removable component 304 is sometimes referred to herein as a vibrator unit. The control signals are configured to cause the at least one vibrating actuator 308 to vibrate, generating a mechanical output force in the form of acoustic vibrations that is delivered to the skull of the recipient via the bone conduction implant 310. In other words, the operationally removable component 304 converts received sound signals into mechanical motion using the at least one vibrating actuator 308 to impart vibrations to the recipient's skull which are detected by the recipient's ossicles and/or cochlea. In certain implementations, the operationally removable component 304 comprises a single housing 305, as schematically illustrated by FIG. 1C, while in certain other implementations, the operationally removable component 304 comprises a plurality of housings (e.g., separate or different housings, which can have wired and/or wireless connections therebetween).

As schematically illustrated in FIG. 1C, the operationally removable component 304 further includes a coupling apparatus 302 configured to operationally removably attach the operationally removable component 304 to a bone conduction implant 310 (also referred to as an anchor system and/or a fixation system) which is implanted in the recipient. The coupling apparatus 302 can be configured to be repeatedly coupled to and decoupled from the bone conduction implant 310. The coupling apparatus 302 comprises a longitudinal axis 306 (e.g., an axis along a length of the coupling apparatus 302; an axis about which the coupling apparatus 302 is at least partially symmetric). The at least one vibrating actuator 308 of the operationally removable component 304 is in vibrational communication with the coupling apparatus 302 such that vibrations generated by the at least one vibrating actuator 308 are transmitted to the coupling apparatus 302 and then to the bone conduction implant 310 in a manner that at least effectively evokes a hearing percept.

The example bone conduction implant 310 of FIG. 1C comprises a percutaneous abutment 312, a bone fixture 318 (hereinafter sometimes referred to as the fixture 318), and an abutment screw 320. While FIG. 1C illustrates one example bone conduction implant 310 in accordance with certain implementations described herein, other bone conduction implants 310 (e.g., comprising abutments 312, fixtures 318, and/or abutment screws 320 of any type, size/having any geometry) are also compatible with certain implementations described herein.

In certain implementations, the coupling apparatus 302 is configured to be removably attached to the bone conduction implant 310 by pressing the coupling apparatus 302 against the abutment 312 in a direction along (e.g., substantially parallel to) the longitudinal axis 306 of the coupling apparatus 302 and/or along (e.g., substantially parallel to) the longitudinal axis 313 of the abutment 312. In certain such implementations, the coupling apparatus 302 can be configured to be snap-coupled to the abutment 312. In certain implementations, as depicted by FIG. 1C, the coupling apparatus 302 comprises a male component and the abutment 312 comprises a female component configured to mate with the male component of the coupling apparatus 302. In certain implementations, this configuration can be reversed, with the coupling apparatus 302 comprises a female component and the abutment 312 comprises a male component configured to mate with the female component of the coupling apparatus 302.

The abutment 312 of certain implementations is symmetrical with respect to at least those portions of the abutment 312 above the top portion of the fixture 318. For example, the exterior surfaces of the abutment 312 can form concentric outer profiles about a longitudinal axis 313 of the abutment 312 (e.g., an axis along a length of the abutment 312; an axis about which the abutment 312 is at least partially symmetric). As shown in FIG. 1C, the exterior surfaces of the abutment 312 establish diameters lying on planes normal to the longitudinal axis 313 that vary along the length of the longitudinal axis 313. For example, the abutment 312 can include outer diameters that progressively become larger with increased distance from the fixture 318. In certain other implementations, the outer diameters can have other outer profiles.

In certain implementations, the abutment 312 is configured for integration between the skin and the abutment 312. Integration between the skin and the abutment 312 can be considered to occur when the soft tissue of the skin 132 encapsulates the abutment 312 in fibrous tissue and does not readily dissociate itself from the abutment 312, which can inhibit the entrapment and/or growth of microbes proximate the bone conduction implant 310. For example, the abutment 312 can have a surface having features which are configured to reduce certain adverse skin reactions. In certain implementations, the abutment 312 is coated to reduce the shear modulus, which can also encourage skin integration with the abutment 213. For example, at least a portion of the abutment 312 can be coated with or otherwise contain a layer of hydroxyapatite that enhances the integration of skin with the abutment 312.

In certain implementations, the abutment 312 is configured to be attached to the fixture 318 via the abutment screw 320, and the fixture 318 is configured to be fixed to (e.g., screwed into) the recipient's skull bone 136. The abutment 312 extends from the fixture 318, through muscle 134, fat 128, and skin 132 so that the coupling apparatus 140 can be attached thereto. The abutment screw 320 (e.g., comprising a screw head 322 and an elongate coupling shaft 324 connected to the screw head 322) connects and holds the abutment 312 to the fixture 318, thereby rigidly attaching the abutment 312 to the fixture 318. The rigid attachment is such that the abutment 312 is vibrationally connected to the fixture 318 such that at least some of the vibrational energy transmitted to the abutment 312 is transmitted to the fixture 318 in a sufficient manner to effectively evoke a hearing percept. The percutaneous abutment 312 provides an attachment location for the coupling apparatus 302 that facilitates efficient transmission of mechanical force.

The fixture 318 can be made of any material that has a known ability to integrate into surrounding bone tissue (e.g., comprising a material that exhibits acceptable osseointegration characteristics). In certain implementations, the fixture 318 is formed from a single piece of material (e.g., titanium) and comprises outer screw threads 326 forming a male screw which is configured to be installed into the skull bone 136 and a flange 328 configured to function as a stop when the fixture 318 is implanted into the skull bone 136. The screw threads 326 can have a maximum diameter of about 3.5 mm to about 5.0 mm, and the flange 328 can have a diameter which exceeds the maximum diameter of the screw threads 326 (e.g., by approximately 10%-20%). The flange 328 can have a planar bottom surface for resting against the outer bone surface, when the fixture 318 has been screwed down into the skull bone 136. The flange 328 prevents the fixture 318 (e.g., the screw threads 326) from potentially completely penetrating completely through the bone 136.

The body of the fixture 318 can have a length sufficient to securely anchor the fixture 318 to the skull bone 136 without penetrating entirely through the skull bone 136. The length of the body can therefore depend on the thickness of the skull bone 136 at the implantation site. For example, the fixture 318 can have a length, measured from the planar bottom surface of the flange 328 to the end of the distal region (e.g., the portion farthest from the flange 328), that is no greater than 5 mm or between about 3.0 mm to about 5.0 mm, which limits and/or prevents the possibility that the fixture 318 might go completely through the skull bond 136.

The interior of the fixture 318 can further include an inner lower bore 330 having female screw threads configured to mate with male screw threads of the elongate coupling shaft 324 to secure the abutment screw 320 and the abutment 312 to the fixture 318. The fixture 318 can further include an inner upper bore 332 that receives a bottom portion of the abutment 312. While FIG. 1C shows the coupling apparatus 302 directly engaging with (e.g., directly contacting) the abutment screw 320 (e.g., the screw head 322), in certain other implementations, the coupling apparatus 302 engages with the abutment 312 without directly engaging with (e.g., without directly contacting) the abutment screw 320.

In certain implementations, the bottom of the abutment 312 includes a fixture connection section extending below a reference plane extending across the top of the fixture 318 and that interfaces with the fixture 318. Upon sufficient tensioning of the abutment screw 320, the abutment 312 sufficiently elastically and/or plastically stresses the fixture 318, and/or visa-versa, so as to form a tight seal at the interface of surfaces of the abutment 312 and the fixture 318. Certain such implementations can reduce (e.g., eliminate) the chances of micro-leakage of microbes into the gaps between the abutment 312, the fixture 318 and the abutment screw 320.

Bone conduction actuators generally utilize resonance to deliver a relatively large dynamic force with very limited electrical current, voltage, and power. For narrower vibrational frequency bandwidths, the power transfer to the recipient's bone (e.g., skull) can be more efficient than for wider vibrational frequency bandwidths. Since human hearing covers a relatively wide vibrational frequency bandwidth, the bone conduction actuators of hearing prosthesis systems can be inefficient and/or can have reduced sound reproduction quality in at one of the bass band and the treble band. In addition, bone conduction actuators can have uneven electrical impedances, and electrical amplifiers that are not optimized for these actuators which can lead to lower efficiency and higher distortion.

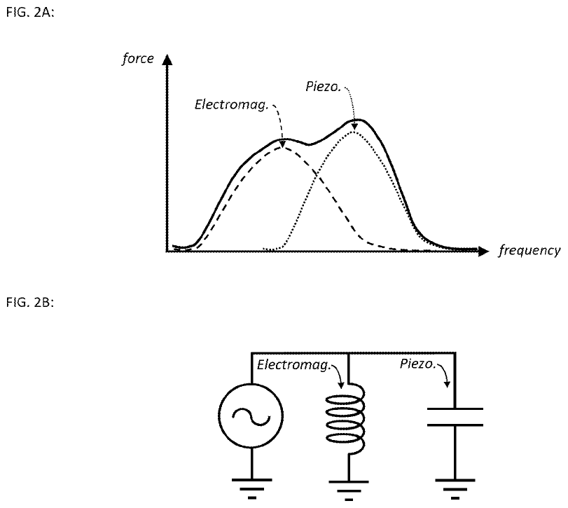

Certain implementations described herein utilize a dual actuator system comprising an electromagnetic transducer and at least one piezoelectric transducer, the system configured to at least partially overcome limitations associated with utilizing a single actuator with a single resonance frequency. FIG. 2A schematically shows a plot of the vibrational frequency bandwidths of an electromagnetic transducer (dashed line), a piezoelectric transducer (dotted line), and the sum of both the bandwidths (solid line) in accordance with certain implementations described herein. By using the electromagnetic transducer to generate vibrations in the low frequency (e.g., bass) region and the piezoelectric transducer to generate vibrations in the high frequency (e.g., treble) region, both overall bandwidth and efficiency can be increased significantly, as compared to single actuator systems.

FIG. 2B schematically illustrates an electromagnetic transducer and a piezoelectric transducer in a parallel electrical circuit in accordance with certain implementations described herein. The circuit (e.g., natural crossover network) can have an electrical impedance that is configured to be tuned (e.g., to be compatible with electrical amplifiers used in conjunction with the electromagnetic and piezoelectric transducers). As shown in FIG. 2B, the electromagnetic transducer is represented by an electrical inductance (e.g., the electrical inductance of a bobbin comprising at least one electrically conductive coil wound around at least a portion of a ferromagnetic or ferrimagnetic core, the bobbin configured to generate a time-varying magnetic field in response to time-varying electrical signals) and the piezoelectric transducer is represented by an electrical capacitance (e.g., the electrical capacitance of at least one piezoelectric element configured to respond to time-varying electrical signals by mechanically oscillating). In certain implementations, the circuit is configured to act as a current divider (e.g., directing electrical current as appropriate to the electromagnetic transducer and/or the piezoelectric transducer). In certain implementations, the electrical impedances of the electromagnetic transducer and the piezoelectric transducer are configured to divide the electrical current among the electromagnetic and piezoelectric transducers as a function of the vibrational frequencies generated by the electromagnetic and piezoelectric transducers.

In certain implementations, the electromagnetic transducer and the piezoelectric transducer are each in electrical communication with separate electrical amplifiers and digital signal processing is used to create a crossover network that is not limited by electrical impedances. In certain such implementations, the crossover network created by the digital signal processing has a high power efficiency since each of the electromagnetic and piezoelectric transducers is used to generate vibrations at frequencies at which they are resonant.

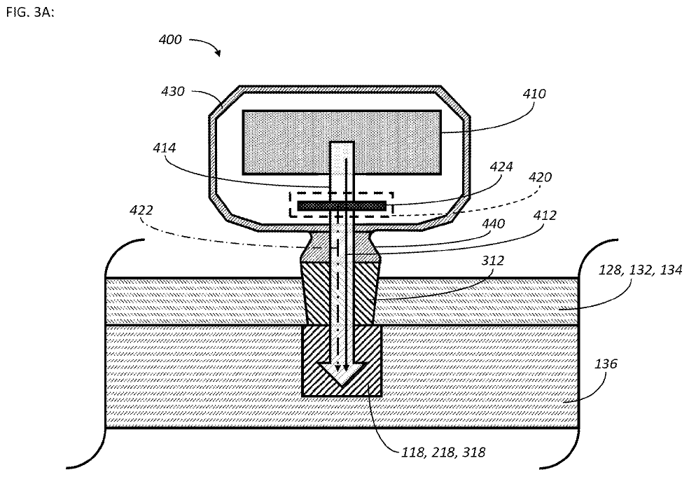

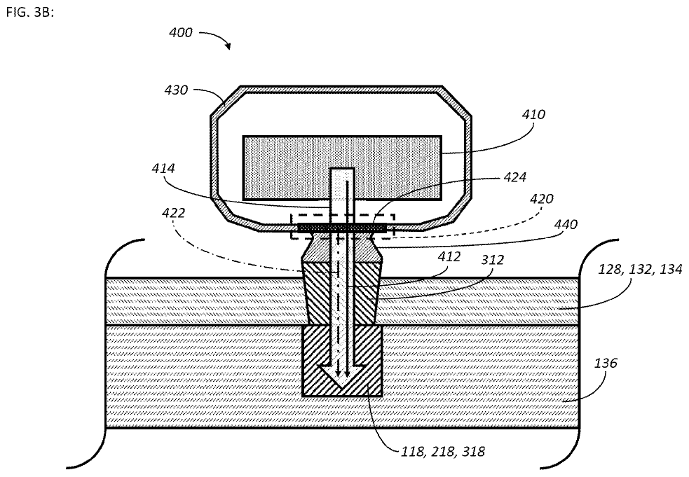

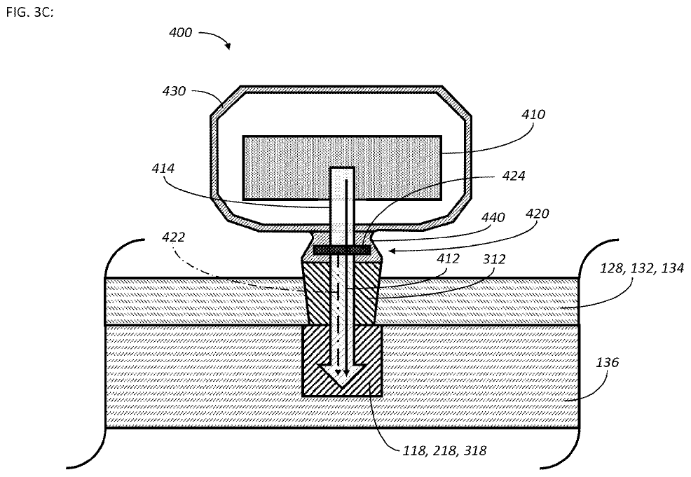

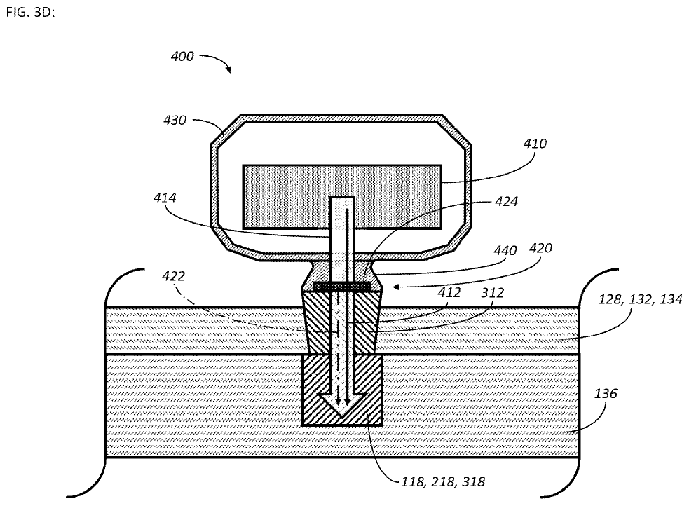

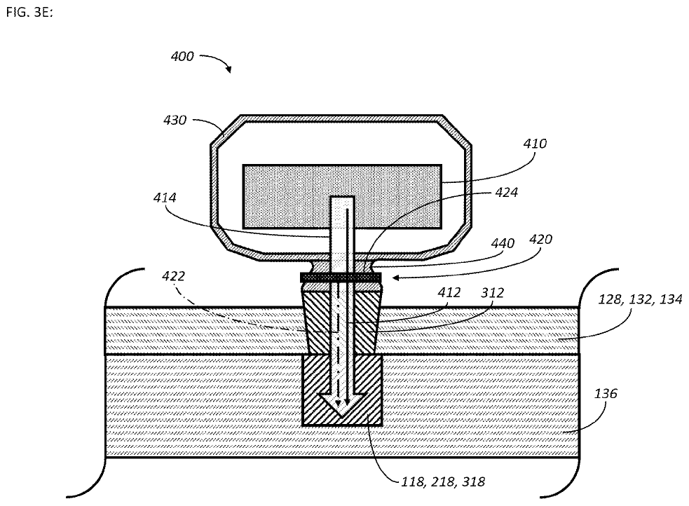

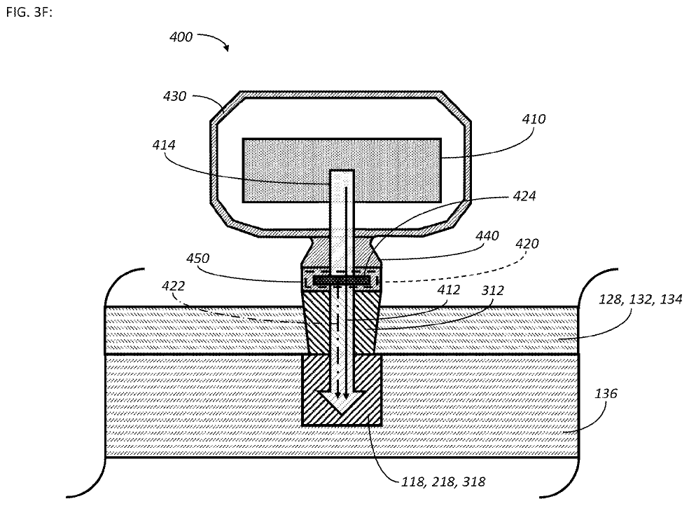

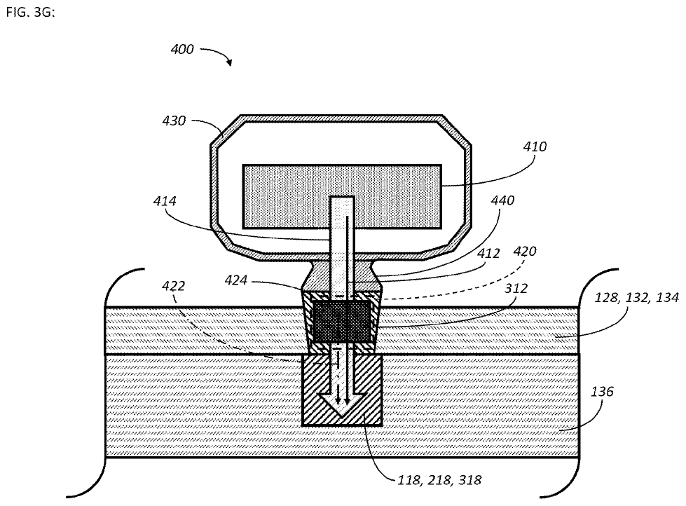

FIGS. 3A-3G schematically illustrate various example apparatus 400 in accordance with certain implementations described herein. The apparatus 400 comprises an electromagnetic transducer 410 configured to generate first vibrations 412 having a first range of vibrational frequencies and to transmit the first vibrations 412 along a transmission path 414 from the electromagnetic transducer 410 to a bone fixture 318 affixed to a recipient's body. The apparatus 400 further comprises at least one piezoelectric transducer 420 positioned along the transmission path 414 (e.g., the transmission path 414 extends through the at least one piezoelectric transducer 420). The example apparatus 400 of FIGS. 3A-3G comprises a housing 430 (e.g., housing 305) and a coupler 440 (e.g., coupling apparatus 302) configured to be reversibly attached to and detached from an abutment 312 extending from the recipient's body and in mechanical communication with the bone fixture 118, 218, 318.

In certain implementations, the electromagnetic transducer 410 (e.g., vibrating actuator 108, 208, 308) comprises a bobbin and at least one mass configured to undergo vibratory motion in response to time-varying magnetic fields generated by the bobbin. The bobbin can comprise at least one ferromagnetic or ferrimagnetic core and at least one electrically conductive coil wound around at least a portion of the core. The bobbin is configured to generate the time-varying magnetic fields in response to time-varying electrical currents flowing through the coil, the magnetic fields applying an attractive magnetic force to the at least one mass. The electromagnetic transducer 410 can further comprise at least one spring in mechanical communication with the at least one mass, the at least one spring configured to resiliently deform (e.g., bend) and to apply a restoring force to the at least one mass in response to movement of the at least one mass. The restoring force and the magnetic force configured such that the at least one mass vibrates in response to the time-varying magnetic fields, thereby creating the first vibrations 412. In certain implementations, the electromagnetic transducer 410 can be configured to optimize performance at lower frequencies (e.g., increasing the number of turns of the at least one electrically conductive coil to have lower impedance at lower frequencies) while degrading performance at higher frequencies which can be provided by the at least one piezoelectric transducer 420. In certain implementations, the electromagnetic transducer 410 comprises at least one first electrical amplifier optimized for the electromagnetic transducer 410.

In certain implementations, the first vibrations 412 generated by the electromagnetic transducer 410 comprise vibrations within a range of vibrational frequencies that are perceptible by the recipient as sound (e.g., a range of 20 Hz to 20 kHz), which are referred to herein as auditory vibrations. These auditory vibrations propagate along the transmission path 414 to the bone fixture 318 and propagate via bone conduction from the bone fixture 318 to an inner ear region (e.g., within the temporal bone and comprising the vestibule, the cochlea, and the semicircular canals) and/or a middle ear region (e.g., within the recipient's head, partially bounded by the tympanic membrane and comprising the ossicles, the round window, the oval window, and the Eustachian tube) to be detected as sound.

In certain implementations, the at least one piezoelectric transducer 420 is configured to generate second vibrations 422 having a second range of vibrational frequencies and to transmit the second vibrations 422 to the bone fixture 118, 218, 318. For example, as schematically illustrated in FIG. 3A, the second vibrations 422 can propagate along (e.g., substantially coincident with) at least a portion of the transmission path 414 between the electromagnetic transducer 410 and the bone fixture 118, 218, 318. In certain implementations, at least a portion of the first range of vibrational frequencies is below the second range of vibrational frequencies. For example, the electromagnetic transducer 410 can have a resonance frequency in the range of 300 Hz to 1000 Hz, the at least one piezoelectric transducer 420 can have a resonance frequency in the range of 2 kHz to 6 kHz, the first range of vibrational frequencies of the first vibrations 412 from the electromagnetic transducer 410 can comprise frequencies less than 1 kHz (e.g., low frequencies; bass), and the second range of vibrational frequencies of the second vibrations 422 can comprise frequencies greater than 2 kHz (e.g., high frequencies; treble). In certain implementations, the at least one piezoelectric transducer 420 comprises at least one second electrical amplifier, different and separate from the at least one first electrical amplifier of the electromagnetic transducer 410, the at least one second electrical amplifier optimized for the at least one piezoelectric transducer 420. In certain implementations, the at least one piezoelectric transducer 420 comprises a non-rigid element (e.g., foam pad; tape) configured to mechanically dampen high frequency ringing by the at least one piezoelectric element 424 (e.g., while not dampening low frequency vibrations from the electromagnetic transducer 410).

In certain other implementations, the at least one piezoelectric transducer 420 is configured to detect vibrations by generating time-varying (e.g., oscillating) electrical signals in response to time-varying (e.g., oscillating) forces applied to the at least one piezoelectric transducer 420. For example, the at least one piezoelectric transducer 420 can be configured to detect the first vibrations 412 and/or vibrations that could interference with proper operation of the apparatus 400 (e.g., from unwanted resonances) and to generate electrical signals indicative of the detected vibrations (e.g., with a relatively flat frequency response). The apparatus 400 can be configured to use the electrical signals generated by the at least one piezoelectric transducer 420 as feedback signals for controlling operation of the apparatus 400.

In certain implementations, the at least one piezoelectric transducer 420 comprises at least one piezoelectric element 424. In certain implementations in which the at least one piezoelectric transducer 420 is configured to generate the second vibrations 422, the at least one piezoelectric element 424 is configured to undergo vibratory (e.g., oscillating) motion in response to time-varying (e.g., oscillating) electrical signals received by the at least one piezoelectric element 424. In certain other implementations in which the at least one piezoelectric transducer 420 is configured to detect vibrations, the at least one piezoelectric element 424 is configured to generate time-varying (e.g., oscillating) electrical signals in response to the detected vibrations.

In certain implementations, the at least one piezoelectric element 424 is a unitary (e.g., single; monolithic) component comprising at least one piezoelectric material, while in certain other implementations, the at least one piezoelectric element 424 comprises separate components, one or more of which each comprising at least one piezoelectric material. Examples of piezoelectric materials compatible with certain implementations described herein include but are not limited to: quartz; gallium orthophosphate; langasite; barium titanate; lead titanate; lead zirconate titanate (PZT); potassium niobate; lithium niobate; lithium tantalate; sodium tungstate; sodium potassium niobate; bismuth ferrite; sodium niobate; polyvinylidene fluoride; macro fiber composite (MFC); other piezoelectric crystals, ceramics, or polymers. The at least one piezoelectric element 424 of certain implementations comprises two or more layers in mechanical communication with one another (e.g., bonded together) into a unitary component (e.g., a stack), at least one of the layers comprising at least one piezoelectric material (e.g., unimorph having one piezoelectric layer and a non-piezoelectric layer; bimorph having two piezoelectric layers). The unitary component can comprise other non-piezoelectric materials, such as a bonding material (e.g., adhesive; epoxy; metal) between the piezoelectric layers and/or electrically conductive material (e.g., metal) configured to apply electrical voltage signals to the piezoelectric layers. In certain implementations, the number of layers of the at least one piezoelectric element 424 are selected to provide a predetermined power, size (e.g., area, thickness), stiffness, and/or resonance frequency. For example, the power of the at least one piezoelectric element 424 can be increased while keeping the same efficiency by having more layers (e.g., power scaling with thickness) which can result in higher stiffness and higher resonance frequencies (e.g., resonance frequency scaling with thickness to the power of 1.5). For another example, the size (e.g., area) of the at least one piezoelectric element 424 can reduced while keeping the same efficiency which can result in higher resonance frequencies and lower voltage-to-force sensitivity (e.g., scaling with area).

In certain implementations, the at least one piezoelectric element 424 is substantially planar (e.g., plate; sheet; disc-shaped; arm) with a length (e.g., in a range of 2 millimeters to 20 millimeters), a width substantially perpendicular to the length (e.g., in a range of 2 millimeters to 20 millimeters), and a thickness substantially perpendicular to the length and to the width (e.g., in a range of less than 2 millimeters; less than 1 millimeter; greater than 300 microns). Various configurations and geometries of the at least one piezoelectric element 424 are compatible with certain implementations described herein (see, e.g., “Piezoelectric Ceramic Products: Fundamentals, Characteristics and Applications,” Physik Instruments (PI) GmbH & Co., Lederhose, Germany, www.piceramic.com, (2016)).

In certain implementations, the at least one piezoelectric element 424 has a first portion affixed to a portion of the apparatus 400 that does not move relative to a housing 430 of the apparatus 300 and a second portion affixed to at least one counterweight configured to move in response to movement of the at least one piezoelectric element 420. In certain implementations, the counterweight comprises at least a portion of the electromagnetic transducer 410 (e.g., the at least one mass of the electromagnetic transducer 410).

In certain implementations, the electromagnetic transducer 410 is on or within the housing 430. In certain implementations, the housing 430 contains at least one processor (e.g., microelectronic circuitry; application-specific integrated circuit; generalized integrated circuits programmed by software with computer executable instructions; sound processor; digital signal processor; analog signal processor) in operative communication (e.g., wired or wireless communication) with both the electromagnetic transducer 410 and the at least one piezoelectric transducer 420. In certain implementations, the at least one processor is configured to receive audio data indicative of ambient sounds from a microphone and/or indicative of media content being watched and/or listened to by the recipient from a media player (e.g., smart phone, smart tablet, smart watch, radio, laptop computer, or other mobile computing device; television; desktop computer, or other non-mobile media player used, worn, held, and/or carried by the recipient). In certain implementations, the at least one processor is in operative communication with at least one storage device (e.g., within the housing 430) configured to store information (e.g., data; commands; software; logic) accessed by the at least one processor during operation of the apparatus 400. The at least one storage device can comprise at least one tangible (e.g., non-transitory) computer readable storage medium, examples of which include but are not limited to: read only memory (ROM); random access memory (RAM); magnetic disk storage media; optical storage media; flash memory. In certain implementations, the at least one processor is further configured to receive user input from the recipient via an input device (e.g., keyboard; touchscreen; buttons; switches; voice recognition system) and to respond to the user input by controlling the apparatus 400 (e.g., the electromagnetic transducer 410 and the at least one piezoelectric transducer 420).

In certain implementations, the at least one processor is configured to respond to the audio data by providing control signals to the electromagnetic transducer 410 and to the at least one piezoelectric transducer 420. For example, the control signals can be configured to adjust (e.g., modify; improve; optimize) one or more parameters of the first and/or second vibrations 412, 422. For example, the at least one processor can be configured to control the electromagnetic transducer 410 to generate the first vibrations 412 in the first range of vibrational frequencies and to generate the second vibrations 422 in the second range of vibrational frequencies. For example, the electromagnetic transducer 410 can be controlled to generate auditory vibrations in the bass range (e.g., low frequency range) and the at least one piezoelectric transducer 420 can be controlled to generate auditory vibrations in the treble range (e.g., high frequency range). In certain implementations, the at least one processor is configured to digitally dampen high frequency ringing of the at least one piezoelectric element 424.

In certain implementations, the at least one piezoelectric transducer 420 is positioned on or within the housing 430. For example, as schematically illustrated by FIG. 3A, the at least one piezoelectric element 424 is within the housing 430 (e.g., between the electromagnetic transducer 410 and the coupler 440). For example, the at least one piezoelectric transducer 420 can be in mechanical communications with the electromechanical transducer 410 (e.g., the at least one piezoelectric transducer 420 using at least a portion of the electromechanical transducer 410 as a mass configured to move in response to movement of the at least one piezoelectric element 420).

In certain implementations, as schematically illustrated by FIG. 3B, the at least one piezoelectric element 424 is on or a part of the housing 430. For example, the apparatus 400 can comprise at least one spring (e.g., a plurality of suspension springs) in mechanical communication with the housing 430 and the coupler 440, and the at least one spring can comprise the at least one piezoelectric transducer 420 (e.g., the at least one piezoelectric element 424). The plurality of suspension springs, including the at least one piezoelectric element 424, can mechanically connect the coupler 440 to the housing 430. In certain implementations, the suspension springs are configured to allow the first vibrations 412 to propagate along the transmission path 414 extending through the coupler 440 while inhibiting first vibrations 412 having low vibrational frequencies (e.g., below 200 Hz) from propagating to the housing 430 from the coupler 440. In certain other implementations, the at least one piezoelectric transducer 420 is configured to receive input signals (e.g., from an accelerometer) indicative of the low vibrational frequencies and driving signals configured to drive the at least one piezoelectric element 424 to cancel out the low vibrational frequencies in the housing 430 that would otherwise cause feedback. For example, the electromagnetic transducer 410 can be driven using higher powers and the resultant increased distortions can be substantially canceled out by the vibrations from the at least one piezoelectric transducer 420.

In certain implementations, as schematically illustrated by FIGS. 3C and 3D, the at least one piezoelectric transducer 420 is positioned within the coupler 440 or, as schematically illustrated by FIG. 3E, the at least one piezoelectric transducer 420 is positioned on the coupler 440. For example, the coupler 440 can be a snap coupler (e.g., coupling apparatus 302) having a distal end configured to mate (e.g., snap) with a corresponding portion of the abutment 312 (e.g., screw head 322). The coupler 440 can comprise a region (e.g., spacer) between the housing 430 and the distal end of the coupler 440 and the at least one piezoelectric element 424 can be within or encircling the region. The region can have a thickness along a direction from the housing 430 to the abutment 312 in a range of 2 millimeters to 4 millimeters and the distal end of the coupler 440 can have a width (e.g., diameter) in a range of 4 millimeters to 8 millimeters.

As shown in FIG. 3C, the at least one piezoelectric element 424 can be spaced from the distal end of the coupler 440. As shown in FIG. 3D, the at least one piezoelectric element 424 can comprise or can be in contact with the distal end of the coupler 440. For example, the distal end of the coupler 440 can comprise a substantially flat portion configured to be in mechanical communication with the abutment 312, and the at least one piezoelectric element 424 can comprise a stack of piezoelectric material layers with a protective coating (e.g., polyurethane) configured to contact and be pressed against a corresponding portion of the abutment 312. As shown in FIG. 3E, the at least one piezoelectric element 424 can be in mechanical communication with a periphery (e.g., perimeter) of the coupler 440, and the at least one piezoelectric element 424 can comprise a ring of at least one piezoelectric material encircling the coupler 440. In certain implementations, the at least one piezoelectric element 424 has a resonance frequency in a range of 2 kHz to 6 kHz (e.g., 4 kHz). To reduce the likelihood of the at least one piezoelectric element 424 experiencing tension, certain implementations have the at least one piezoelectric element 424 under pre-compression.

In certain implementations, the apparatus 400 further comprises a coupling extender 450 configured to be reversibly attached to and detached from the coupler 440 and reversibly attached to and detached from the abutment 312, and the at least one piezoelectric transducer 420 is positioned on or within the coupling extender 450. For example, the coupler 440 can be a snap coupler (e.g., coupling apparatus 302) configured to mate (e.g., snap) with the coupling extender 450, and the coupling extender 450 can be configured to mate (e.g., snap) with a corresponding portion of the abutment 312 (e.g., screw head 322). The at least one piezoelectric element 424 can be a stack of piezoelectric material layers and/or a ring of at least one piezoelectric material within the coupling extender 450 (e.g., as shown in FIG. 3F) or encircling the coupling extender 450. The coupling extender 450 can have a thickness along a direction from the housing 430 to the abutment 312 in a range of 2 millimeters to 4 millimeters and a width (e.g., diameter) in a range of 4 millimeters to 8 millimeters. In certain implementations, the coupling extender 450 comprising the at least one piezoelectric transducer 420 can be configured to be used as an add-on to a conventional transcutaneous bone conduction device 100, 200 or percutaneous bone conduction device 300 comprising an electromagnetic transducer 410 to supplement the vibrations from the electromagnetic transducer 410 with additional vibrations (e.g., in a range of vibrational frequencies extending higher than the range of vibrational frequencies from the electromagnetic transducer 410).

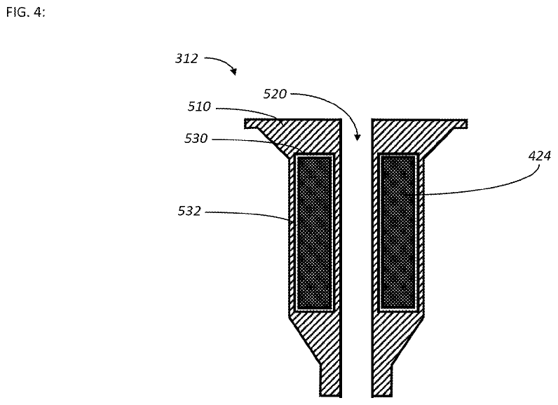

In certain implementations, as schematically illustrated by FIG. 3G, the abutment 312 comprises the at least one piezoelectric transducer 420. FIG. 4 schematically illustrates a cross-sectional view of an example abutment 312 in accordance with certain implementations described herein. The example abutment 312 of FIG. 4 comprises a solid body 510 (e.g., titanium), a hole 520 extending through the body 510 (e.g., configured to receive an abutment screw 320), and a substantially cylindrical cavity 530 that is substantially concentric around the hole 520. The at least one piezoelectric element 424 can be substantially cylindrical (e.g., ring) and positioned within the cavity 530 of the abutment 312. The at least one piezoelectric element 424 can be affixed within the cavity 530 by an adhesive 532 (e.g., epoxy). In certain implementations, the at least one piezoelectric element 424 is encased in a relatively soft material (e.g., silicone) configured to transfer low frequency vibrations from the electromagnetic transducer 410 while allowing high frequency operation of the at least one piezoelectric element 424. Electrical communication with the at least one piezoelectric element 424 can be achieved using various means (e.g., electrode connections between the abutment 312 and the coupler 440; wireless communication via inductively coupled coils; ultrasonic power transfer).

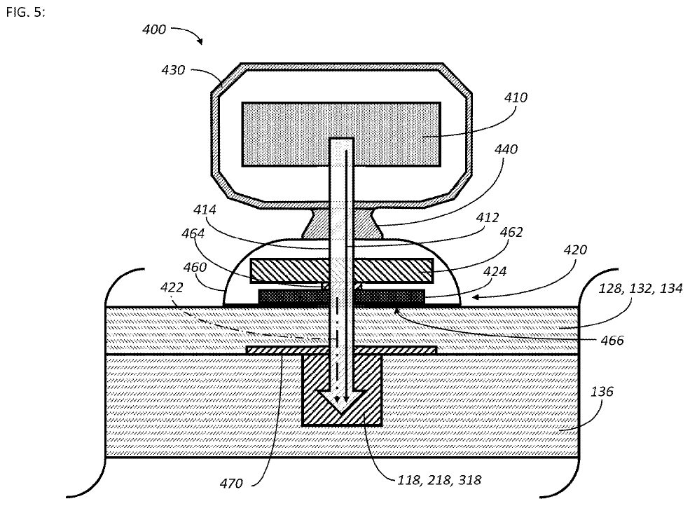

In certain implementations, the apparatus 400 comprises a second housing 460 comprising a magnet 462 (e.g., plate 112; permanent magnet) configured to generate an attractive magnetic force with a ferromagnetic or ferrimagnetic element 470 (e.g., implanted plate assembly 114) in mechanical communication with the bone fixture 118, 218, 318. The second housing 460 is configured to be reversibly attached to and detached from the first housing 430 and the at least one piezoelectric transducer 420 is on or within the second housing 460. For example, as schematically illustrated by FIG. 5, the coupler 440 is affixed to the first housing 430 and is configured to be reversibly attached to and detached from the second housing 460. In certain implementations, the attractive magnetic force between the magnet 462 and the ferromagnetic or ferrimagnetic element 470 is configured to be sufficient to hold the second housing 460 against the skin 132 of the recipient (e.g., with the second housing 460 attached to the coupler 440 affixed to the first housing 430). The at least one piezoelectric element 424 of certain implementations is in mechanical communication with at least one counter mass comprising the magnet 462 (e.g., via a spacer 464) and is configured to oscillate the magnet 462 to produce the second vibrations 422.

In certain implementations, the at least one piezoelectric element 424 is affixed to a distal wall 466 of the second housing 460, the distal wall 466 is configured to contact the skin 132 of the recipient. The distal wall 466 of certain implementations is sufficiently flexible to allow the at least one piezoelectric element 424 to bend. For example, the second housing 460 can comprise plastic and the distal wall 466 can comprise titanium (e.g., coated with plastic or another thermally insulative material so that the distal wall 466 does not substantially conduct heat away from the recipient's skin 132 to feel cold to the recipient).

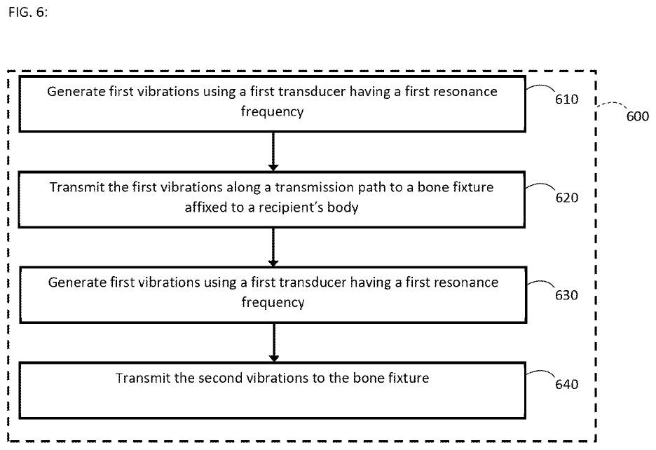

FIG. 6 is a flow diagram of an example method 600 in accordance with certain implementations described herein. While the method 600 is described by referring to some of the structures of the example apparatus 400 of FIGS. 3A-3G and 5, other apparatus and systems with other configurations of components can also be used to perform the method 600 in accordance with certain implementations described herein. In certain implementations, a non-transitory computer readable storage medium has stored thereon a computer program that instructs a computer system to perform the method 600.

In an operational block 610, the method 600 comprises generating first vibrations using a first transducer having a first resonance frequency. For example, the first transducer can comprise an electromagnetic transducer 410 having a first resonance frequency in a range of 300 Hz to 1000 Hz and configured to generate the first vibrations 412.

In an operational block 620, the method 600 further comprises transmitting the first vibrations along a transmission path to a bone fixture affixed to a recipient's body. For example, the first vibrations 412 from the electromagnetic transducer 410 can propagate along the transmission path 414 to the bone fixture 118, 218, 318.

In an operational block 630, the method 600 further comprises generating second vibrations using a second transducer positioned along the transmission path, the second transducer having a second resonance frequency. For example, the second transducer can comprise at least one piezoelectric transducer 420 positioned along the transmission path 414, having a second resonance frequency in a range of 2 kHz to 6 kHz, and configured to generate the second vibrations 422. In certain implementations, generating the first vibrations in the operational block 610 and generating the second vibrations in the operational block 630 are performed in response to electrical signals indicative of sound detected by at least one microphone. In certain implementations, generating the first vibrations in the operational block 610 and generating the second vibrations in the operational block 630 are performed simultaneously.

In an operational block 640, the method 600 further comprises transmitting the second vibrations to the bone fixture. For example, the second vibrations 422 from the at least one piezoelectric transducer 420 can propagate along the transmission path 414 to the bone fixture 118, 218, 318.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of various devices, various implementations described herein can be incorporated in a variety of other suitable devices, methods, and contexts. More generally, as can be appreciated, certain implementations described herein can be used in a variety of implantable medical device contexts that can benefit from certain attributes described herein.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within +10% of, within +5% of, within +2% of, within +1% of, or within +0.1% of the stated amount. As another example, the terms “generally parallel” and “substantially parallel” refer to a value, amount, or characteristic that departs from exactly parallel by +10 degrees, by +5 degrees, by +2 degrees, by +1 degree, or by +0.1 degree, and the terms “generally perpendicular” and “substantially perpendicular” refer to a value, amount, or characteristic that departs from exactly perpendicular by +10 degrees, by +5 degrees, by +2 degrees, by +1 degree, or by +0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein but should be defined only in accordance with the claims and their equivalents.

1. An apparatus comprising:
an electromagnetic transducer configured to generate first vibrations having a first range of vibrational frequencies and to transmit the first vibrations along a transmission path from the electromagnetic transducer to a bone fixture affixed to a recipient's body; and
at least one piezoelectric transducer positioned along the transmission path.

2. The apparatus of claim 1, wherein the at least one piezoelectric transducer is configured to generate second vibrations having a second range of vibrational frequencies and to transmit the second vibrations to the bone fixture.

3. The apparatus of claim 1, wherein the at least one piezoelectric transducer is configured to detect vibrations.

4. The apparatus of claim 1, wherein the electromagnetic transducer comprises:
a bobbin comprising at least one core and at least one electrically conductive coil wound around at least a portion of the bobbin, the bobbin configured to generate time-varying magnetic fields in response to time-varying electrical currents received by the at least one electrically conductive coil; and
at least one mass configured to undergo vibratory motion in response to the time-varying magnetic fields.

5. The apparatus of claim 1, wherein the at least one piezoelectric transducer comprises at least one piezoelectric element configured to undergo vibratory motion in response to second time-varying electrical signals received by the at least one piezoelectric element.

6. The apparatus of claim 1, wherein at least a portion of the first range of vibrational frequencies is below the second range of vibrational frequencies.

7. The apparatus of claim 1, further comprising a first housing, wherein the electromagnetic transducer is on or within the first housing.

8. The apparatus of claim 7, wherein the at least one piezoelectric transducer is positioned on or within the first housing.

9. The apparatus of claim 1 further comprising a coupler configured to be reversibly attached to and detached from an abutment extending from the recipient's body, the abutment in mechanical communication with the bone fixture.

10. The apparatus of claim 9, further comprising at least one spring in mechanical communication with the coupler and the first housing, the at least one spring comprising the at least one piezoelectric transducer.

11. The apparatus of claim 9, wherein the at least one piezoelectric transducer is positioned on or within the coupler.

12. The apparatus of claim 9, further comprising a coupling extender configured to be reversibly attached to and detached from the coupler and reversibly attached to and detached from the abutment, wherein the at least one piezoelectric transducer is positioned on or within the coupling extender.

13. The apparatus of claim 9, wherein the abutment comprises the at least one piezoelectric transducer.

14. The apparatus of claim 7, further comprising a second housing comprising a magnet configured to generate an attractive magnetic force with a ferromagnetic or ferrimagnetic element in mechanical communication with the bone fixture, wherein the second housing is configured to be reversibly attached to and detached from the first housing, the at least one piezoelectric transducer on or within the second housing.

15. The apparatus of claim 14, wherein the at least one piezoelectric transducer comprises at least one counter mass and at least one piezoelectric element in mechanical communication with the at least one counter mass, the at least one counter mass comprising the magnet.

16. A method comprising:
generating first vibrations using a first transducer having a first resonance frequency in a range of 300 Hz to 1000 Hz;
transmitting the first vibrations along a transmission path to a bone fixture affixed to a recipient's body;
generating second vibrations using a second transducer positioned along the transmission path, the second transducer having a second resonance frequency in a range of 2 kHz to 6 kHz; and
transmitting the second vibrations to the bone fixture.

17. The method of claim 16, wherein said generating the first vibrations and said generating the second vibrations are performed in response to electrical signals indicative of sound detected by at least one microphone.

18. The method of claim 17, wherein said generating the first vibrations and said generating the second vibrations are performed simultaneously.

19. An apparatus comprising:
a coupler configured to be reversibly attached to and detached from an abutment in mechanical communication with a fixture affixed to a recipient's body, the abutment extending from the recipient's body;
an electromagnetic transducer in mechanical communication with the coupler and configured to generate first vibrations and to transmit the first vibrations from the electromagnetic transducer via the coupler and the abutment to the fixture; and
at least one piezoelectric transducer positioned between the electromagnetic transducer and the fixture, the at least one piezoelectric transducer configured to generate second vibrations and to transmit the second vibrations to the fixture.

20. The apparatus of claim 19, wherein the at least one piezoelectric transducer is configured to transmit the second vibrations to the fixture via the coupler and/or the abutment.

21. The apparatus of claim 19, wherein the electromagnetic transducer comprises at least one electrically conductive coil wound around at least a portion of a ferromagnetic or ferrimagnetic core and the at least one piezoelectric transducer comprises at least one piezoelectric element in parallel electrical communication with the at least one electrically conductive coil.
